(19) United States
(12) Patent Application Publication
(10) Pub. No.: US 2006/0213559 A1
(43) Pub. Date: Sep. 28, 2006

(54) Toilet cistern filling valve

(76) Inventor: James Churchhill Haslam, JOHANNESBURG, GAUTENG (ZA)

Correspondence Address: STEVENS DAVIS MILLER & MOSHER, LLP, 1615 L STREET, NW, SUITE 850, WASHINGTON, DC, 20036, US

(21) Appl. No.: 10/548,195

(22) PCT Filed: Mar. 8, 2004
(86) PCT No.: PCT/IB04/00621

§ 371 Date: Sep. 7, 2005

(30) Foreign Application Priority Data
Mar. 10, 2003 (ZA) 2003/1926

(51) Int. Cl. F16K 31/18

(52) U.S. Cl. 137/414

(57) ABSTRACT

This invention provides a pressure assisted valve for filling toilet cisterns. The valve has a chamber with an inlet and an annular outlet around the inlet. A diaphragm closure member is located over the inlet and outlet with its upper surface exposed to the chamber. Located through the diaphragm is an axially movable pintle and a chamber vent opening from the chamber is closable by an enlarged upper end of the pintle. The pintle is has longitudinal ribs on its outer surface to provide a bleed passage past the diaphragm. The lower end of the pintle is supported in a perforated guide in the inlet which is resiliently biased to close the enlarged end of the pintle against the chamber vent opening. A control spindle extends through the chamber vent opening from the enlarged end of the pintle. A manipulating mechanism acts on the spindle to move the pintle to open the chamber vent opening. The valve makes use of differential surfaces on the diaphragm to control the flow of water from the inlet to the outlet.

### FIELD OF THE INVENTION

This invention relates to filling valves for toilet cisterns and more particularly to automatically closing valves.

### BACKGROUND TO THE INVENTION

Toilet filling valves which operate to close against pressure under the influence of a float mounted on a lever arm are widely used. They are however subject to leakage and consequently it is desirable to have such a valve which is pressure assisted.

### OBJECT OF THE INVENTION

It is an object of this invention to provide a compact, reliable, pressure assisted cistern filling valve.

### SUMMARY OF THE INVENTION

In accordance with this invention there is provided a pressure assisted valve having an inlet into a chamber and an outlet from the chamber, wherein the inlet and outlet open adjacent each other into the chamber separated by a seal face for a diaphragm closure member in the chamber, with an axially movable pintle located through the diaphragm, a chamber vent opening from the chamber closable by an enlarged end to the pintle, a control spindle extending from the enlarged end of the pintle through the chamber vent opening, at least one bleed passage past the pintle into the chamber, and a manipulating mechanism at the spindle end to move the pintle to open the chamber vent opening.

A further feature of the invention provides for the outlet to be formed around the inlet.

A further feature of this invention provides for the manipulating mechanism to be an arm pivoted at one end and having depending from the other a combination float and anti-float assembly, the assembly being adjustable in height relative to the valve and guided on a cistern filling pipe.

Further features of this invention provide for the pintle to be a composite structure of plastics material with a metal spindle having one end embedded therein, for the bleed passage to be provided by ribs located around and extending along the pintle slidable through the diaphragm and for the ribs to act as a filter.

The invention also provides for the pintle to be supported by a perforated guide in the valve inlet, for the guide to be resiliently biased to close the enlarged end of the pintle against the chamber vent opening and for the enlarged end to form a tapered plug.

Further features of the invention provide for the chamber vent opening to be lined with resilient material and for the diaphragm to have an annular ring of increased flexibility adjacent its outer periphery.

### BRIEF DESCRIPTION OF THE DRAWINGS

These and other features of this invention will become apparent from the following description of three embodiments, by way of example only, wherein reference is made to the accompanying drawings in which:

FIG. 1 shows a cross-section through a valve having a side type inlet in the closed position;

FIG. 2 shows a cross-section through the valve shown in FIG. 1 in the open position together with its valve operating mechanism;

FIG. 3 shows a cross-section through an alternative embodiment of a valve with a side type inlet in the closed position;

FIG. 4 shows the valve of FIG. 3 together with its valve operating mechanism;

FIG. 5 shows a cross-section through a valve having a bottom type inlet in the closed position with its valve operating mechanism.

### DETAILED DESCRIPTION OF THE INVENTION

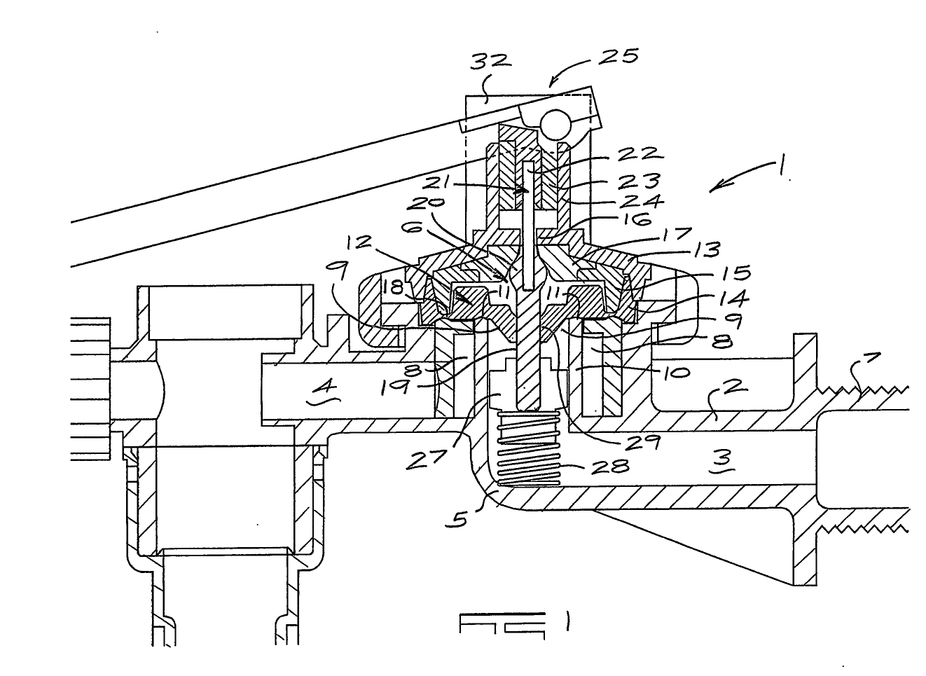

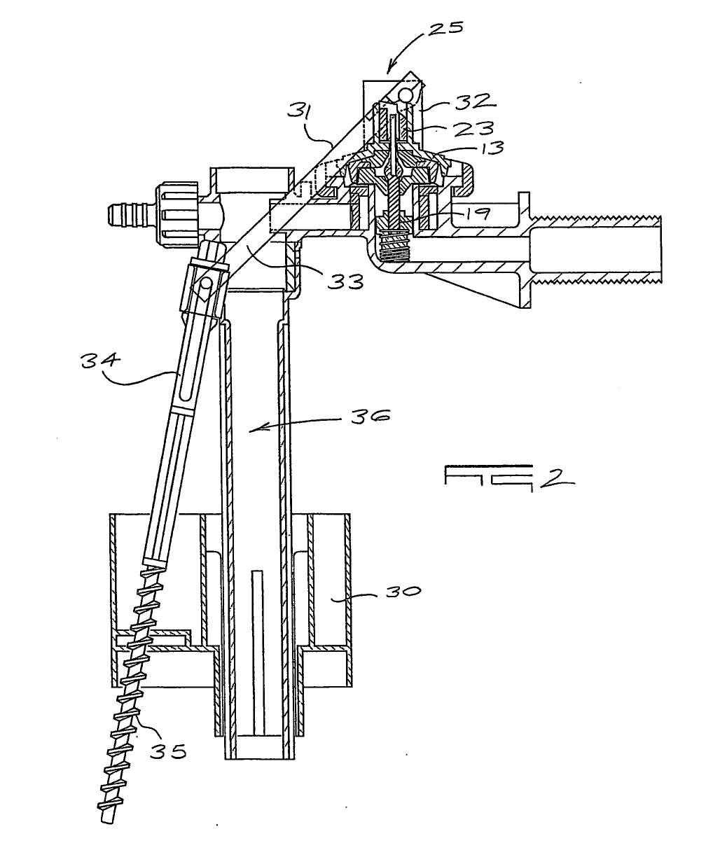

As illustrated in FIGS. 1 and 2, one embodiment of a toilet cistern filling valve (1) consists of a body (2) having an inlet (3) and an annular outlet (4) around the inlet (3) into a cistern (not shown). The inlet (3) extends from the side of the valve (1) and has an upward bend (5) to open into a chamber (6).

The inlet (3) has a screw threaded connection (7) to enable the valve (1) to be secured to extend through the cistern wall for connection into a water supply under pressure. The chamber (6) has an annular outlet opening (8) concentric around the inlet opening (9). The inlet opening (9) and outlet opening (8) are separated by a tubular extrusion (10), the top end of which forms an annular seal face (11). The face (11) is engageable by a diaphragm closure member (12) to control flow between the openings (8) and (9).

The chamber (6) has a top (13) which is made as a closure which secures the peripheral portion (14) of the diaphragm (12) in position in sealing engagement. This engagement can conveniently be effected by a rigid ring (15) inserted above the diaphragm (12) to be clamped in position by the top (13).

The top (13) has a central vent opening (16) which is lined with resilient material in the form of a resilient seal (17) located around the vent opening (16) between the top (13) and the ring (15). The ring (15) supports the resilient seal (17). In this embodiment, the top (13) is secured to the body (2) by bayonet type engaging formations, however any other suitable arrangement for engagement of these components (13) and (2) can be provided.

To give the diaphragm (12) the resilience required for its best operation an annular thin section (18) provides increased flexibility adjacent its periphery. This enables the central part to move easily into and out of the closure position on the face (11) located between the inlet opening (9) and annular outlet opening (8).

The central part of the diaphragm (12) is tapered downwardly into the inlet opening (9) and a preferably moulded plastics material pintle (19) extends through the center of the diaphragm (12). The upper end of the pintle (19) is operatively located within the chamber (6) and has an enlargement on its end in the form of a tapered plug (20).

This plug (20) engages in the resilient seal (17) to close the vent opening (16) from the chamber (6).

A preferably stainless steel operating spindle (21) is embedded in the pintle (19) to extend through the vent opening (16) where the free end (22) is located in a recess provided in a slide (23). The slide (23) is supported in an extension (24) from the top (13) of the chamber (6). The upper face of slide (23) is exposed and can be engaged by a suitable manipulating mechanism indicated at (25).

The lower end of the pintle (19) is secured to a slidable guide (27) that is located in the inlet (3) to the body (2). This guide (27) is perforated to allow water to flow through the valve (1) and is also resiliently biased by a compression spring (28) to assist the closure of the plug (20) against the seal (17).

Essential to the construction is a bleed passage indicated at (29) providing for a bleed flow from the inlet (3) into the chamber (6) above the diaphragm (12). This passage (29) between the pintle (19) and the diaphragm (12) is provided by ribs located around and extending along the pintle (19) which slides in the diaphragm (12). The ribs act as a filter to prevent debris entrained in the inlet water supply from entering the chamber (6). This in turn ensures that the passageway that opens during operation of the valve (1), between the tapered plug (20) and the seal (17), will not become filled with obstructing debris.

The manipulating mechanism (25) and consequently the operation of the filling valve (1) is activated by the influence of the rise and fall of the water level in the cistern on a combination float and anti-float assembly (30) such that when the cistern flushing valve is opened the filling valve (1) will open. The flushing valve (not shown) closes automatically after discharge of water and the filling valve (1) closes after the cistern has been filled as required.

FIG. 2 illustrates the operating means for the valve (1) of FIG. 1.

An arm (31) is pivoted to a projection (32) from the top (13) adjacent the exposed face of slide (23). The arm (31) is shaped so that pivoting thereof in an operatively downward direction will depress the slide (23) and consequently the tapered plug (20) to open the vent opening (16) from the chamber (6).

The free end (33) of the arm (31) has a downwardly depending rod (34) screw threaded at its lower end (35). This end (35) engages the combination float and anti-float assembly (30) in a manner enabling the position of assembly (30) to be adjustable within the toilet cistern.

The assembly (30) can conveniently be guided for movement on a cistern filling pipe (36) discharging into the lower part of the cistern in conventional manner.

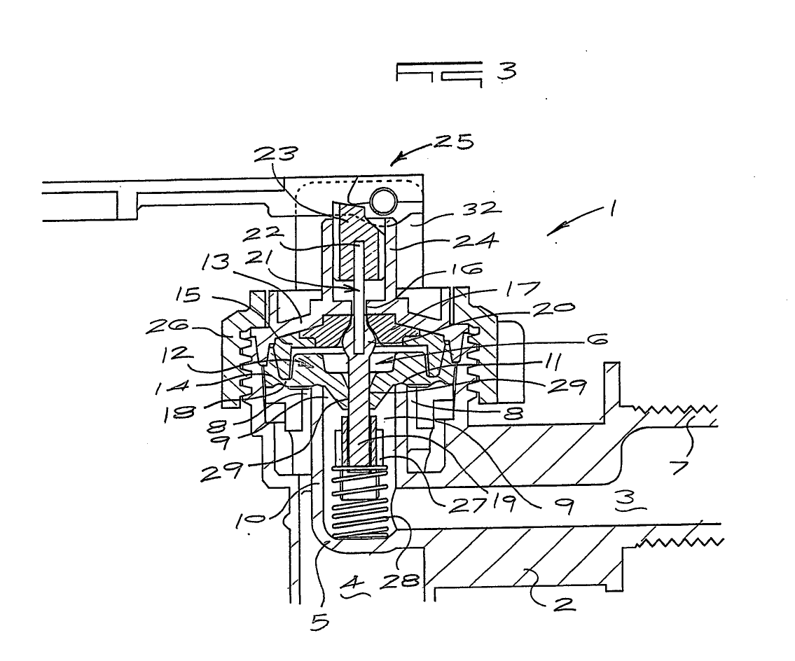

The embodiment of the valve (1) shown in FIG. 3 is substantially the same as that of FIG. 1. Both Figures are accordingly labeled with the same reference numerals. The main difference is that the valve (1) in FIG. 3 is adapted for mounting directly above the filling pipe (36). This valve (1) also has a union nut (26) which engages with threads on the body (2) to secure the top (13) in position.

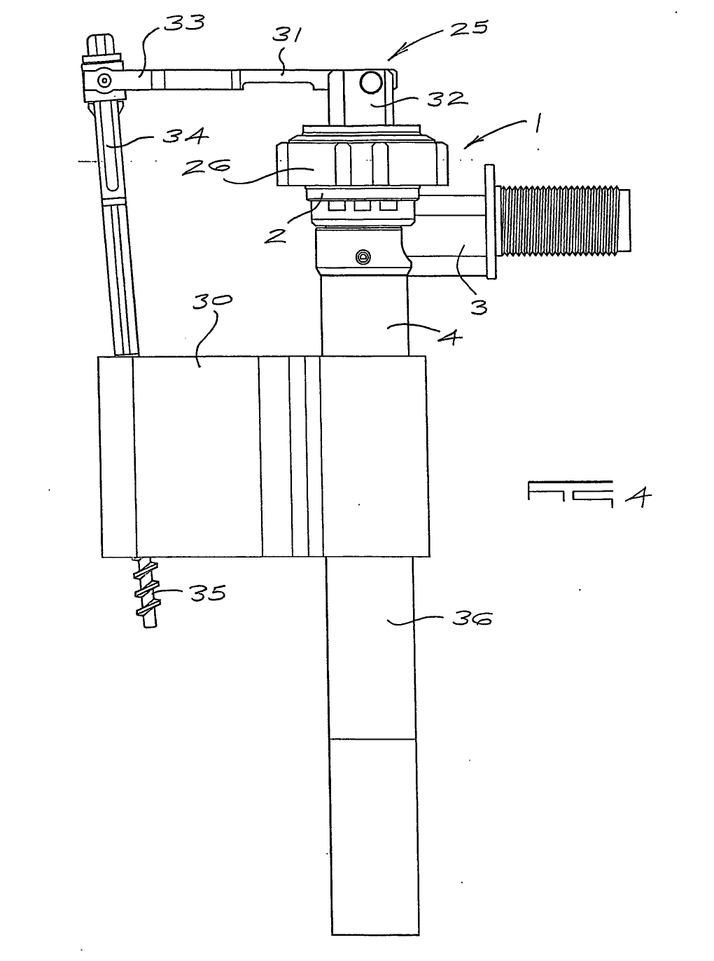

The position of this embodiment of the valve (1) can be seen more clearly from FIG. 4, which also shows the union nut (26) and operating mechanism.

In use, as mentioned, flushing of the cistern causes automatic opening of the inlet valve (1).

The drop of water level in the cistern brings the anti-float component of assembly (30) into effect to pull rod (34) and thus the arm (31) downwards activating slide (23) and spindle (21) to cause the tapered plug (20) to move out of sealing engagement with seal (17).

This enables water to flow from chamber (6) through vent opening (16) resulting in a pressure reduction in chamber (6) as water flow into the chamber (6) is restricted by the bleed passage indicated at (29). Under differential water pressure from the inlet (3), diaphragm (12) is flexed to open the inlet (3) to the outlet (4) to allow water to flow to fill the cistern.

As the cistern fills the bleed flow through passage (29) passes through chamber outlet opening (16) until the float component of assembly (30) becomes effective. The arm (31) then rises to relieve the downward force exerted on the face of slide (23) by the ballast effect out of water of the anti-float component of assembly (30) on arm (31). This relief causes the slide (23), spindle (21) and plug (20) to move, under action of inlet water pressure and the resilient biasing of spring (28), to a position wherein sealing engagement is re-established between plug (20) and resilient seal (17).

When this occurs water bleeding into the chamber (6) from the inlet (3) fills the chamber (6) causing the diaphragm (12) to close onto face (11) under the differential force exerted by the same water pressure on the greater area of the diaphragm (12) on the chamber (6) side compared to the smaller area of diaphragm (12) exposed to water inlet pressure on its opposite side. This differential force holds valve (1) closed thus providing a reliable cistern filling valve (1) that will give a controlled filling volume and pressure assisted closure of the valve (1).

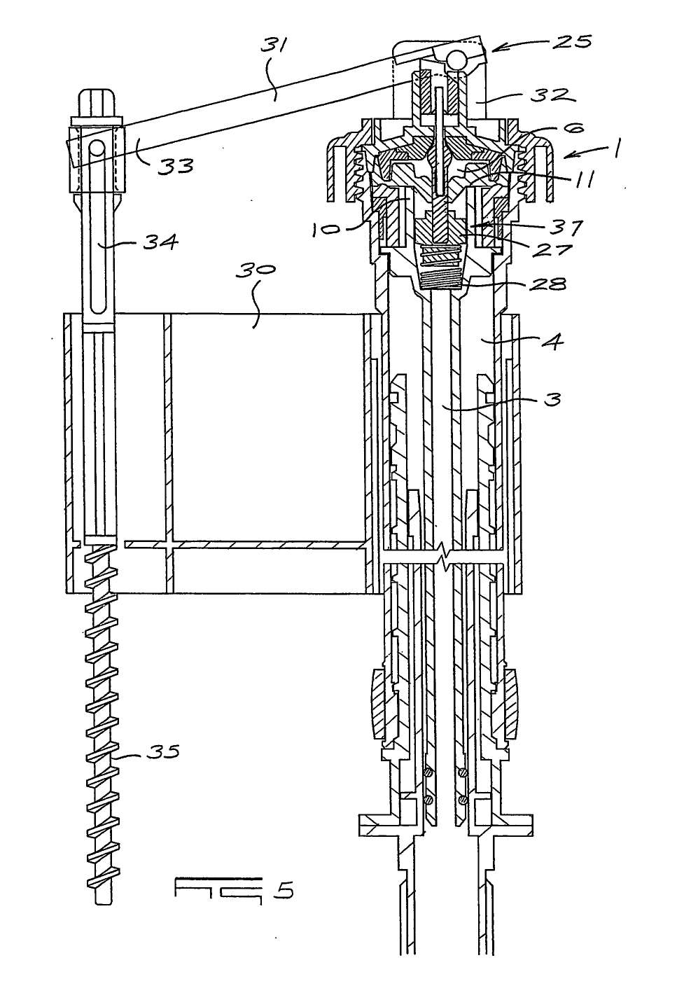

FIG. 5 shows a valve (1) with a bottom type inlet (3) but otherwise substantially the same as those already described. The inlet (3) is straight and extends upwardly from the bottom of the cistern. The inlet (3) similarly opens into the chamber (6). The length of the inlet (3) from the bottom of the cistern is of a smaller diameter than an upper portion (37) spaced apart from the seal face (11). The enlarged portion (37) of the inlet (3) houses the slidable guide (27). An annular shoulder is provided at the lower end of the portion (37) against which the compression spring (28) seats. The upper region of the portion (37) forms the tubular extrusion (10).

This embodiment allows for the float and anti-float assembly (30) to be guided for movement on the inlet pipe as shown.

A number of variations can be made to the described embodiments of the valve without departing from the scope of this invention. These variations will be appreciated by a suitably skilled person. It will also be appreciated that the application of the pressure assisted valve will not be limited to the filling of toilet cisterns.

1. A pressure assisted valve having an inlet into a chamber and an outlet from the chamber, with the inlet and outlet opening adjacent each other into the chamber separated by a seal face for a diaphragm closure member located in the chamber, an axially movable pintle located through the diaphragm, a chamber vent opening from the chamber closable by an enlarged end of the pintle, a control spindle extending from the enlarged end of the pintle through the chamber vent opening, at least one bleed passage located between the pintle and the diaphragm into the chamber, and a manipulating mechanism at the spindle end to move the pintle to open the chamber vent opening, wherein the pintle and spindle are of a composite structure with the pintle of plastics material and the spindle of metal.

2. A valve as claimed in claim 1, wherein one end of the spindle is embedded into the enlarged end of the pintle.

3. A valve as claimed in claim 1, wherein the spindle is stainless steel.

4. A valve as claimed in claim 1, wherein the outlet is formed around the inlet.

5. A valve as claimed in claim 1, wherein the manipulating mechanism is an arm pivoted at one end to the valve and extending from the pivot to engage the free end of the spindle, with a combination float and anti-float assembly depending from the other end.

6. A valve as claimed in claim 5, wherein the arm engages the spindle through a slide supported in an extension from the valve.

7. A valve as claimed in claim 6, wherein the assembly is adjustable in height relative to the end of the arm and guided on a cistern filling pipe.

8. A valve as claimed in claim 1, wherein the bleed passage is provided by ribs located around and extending along the pintle slidable through the diaphragm.

9. A valve as claimed in claim 8, wherein the ribs act as a filter.

10. A valve as claimed in claim 1, wherein the pintle is supported by a perforated guide in the valve inlet, resiliently biased to close the enlarged end of the pintle against the chamber vent opening.

11. A valve as claimed in claim 1, wherein the enlarged end of the pintle forms a tapered plug.

12. A valve as claimed in claim 1, wherein the chamber vent opening is lined with resilient material.

13. A valve as claimed in claim 1 wherein the diaphragm has an annular ring of increased flexibility adjacent its outer periphery.
